(19) United States
(12) Patent Application Publication
(10) Pub. No.: US 2016/0275581 A1
(43) Pub. Date: Sep. 22, 2016

(54) METHOD AND SYSTEM FOR BROADCASTS OF EVENT REQUEST FOR PROPOSAL

(71) Applicant: HOSPITALITY ENGAGEMENT CORPORATION, Cleveland, OH (US)

(72) Inventors: JOHN P. WESTON, ROCKY RIVER, OH (US); BRIAN STEIN, SOLON, OH (US); EVAN B. COOPER, CHAGRIN FALLS, OH (US); NICK PAVLAK, CLEVELAND HEIGHTS, OH (US); ANDREW WOZNIAK, CHARDON, OH (US); ROBERT CLARK, CLEVELAND, OH (US)

(21) Appl. No.: 15/073,956

(22) Filed: Mar. 18, 2016

Related U.S. Application Data
(60) Provisional application No. 62/136,106, filed on Mar. 20, 2015.

(51) Int. Cl. G06Q 30/06; G06Q 20/32

(52) U.S. Cl. CPC G06Q 30/0611; G06Q 30/0621; G06Q 20/322

(57) ABSTRACT

Systems and methods of the invention relate to a computing device that can be configured to manage communications between a merchant mobile device and a customer mobile device, wherein such communications can be utilized to communicate an event request for proposal to which a particular merchant can respond with a customized merchant proposal. The computing device and related communications afford one or more merchants to selectively respond to specific customer event requests as well as having the merchant responses be tailored to each customer event request. Upon a customer acceptance received from the customer mobile device, an acceptance code can be delivered to the merchant for redemption of the merchant proposal.

### CROSS-REFERENCE TO RELATED APPLICATIONS

This application claims the benefit of U.S. Provisional Application Ser. No. 62/136,106, filed Mar. 20, 2015, and entitled “METHOD AND SYSTEM FOR BROADCASTS OF EVENT REQUEST FOR PROPOSAL.” The entirety of the aforementioned application is incorporated herein by reference.

### BACKGROUND

1. Technical Field

Embodiments of the subject matter disclosed herein relate to a system that broadcasts an event request for proposal to which a merchant mobile device can selectively respond to with a merchant proposal that is in response to and can be customized for the event request for proposal. The system can be a platform, a service, a software-as-a-service, a marketplace, or a combination of components.

2. Discussion of Art

Retailing is an exchange (e.g., a sale and a purchase) of goods and/or services between a merchant and a customer. In an example, negotiation can be absent between a merchant and a customer in terms of a sale of the good or service. Retailing can employ a vendor-controlled format in which the merchant can determine which goods or services to offer for sale, when the goods or services will be offered for sale, and the non-negotiable fixed price at which the good or service will be sold. Typically, merchants provide mass offers for good or services in which no customer customization is provided. Mass offers are often more prevalent since manufacturing non-customized goods or services have a lower overhead.

It may be desirable to improve the existing retailing.

### BRIEF DESCRIPTION

In an embodiment, a computing device that executes a portion of a software application that establishes a relationship between a customer mobile device and a merchant mobile device to facilitate completing a sale of a customized tailored good or service, wherein the customized tailored good or service is selectively delivered to an event request for proposal from the customer mobile device. The system described herein can be a platform, a service, a software-as-a-service, a marketplace, or a combination of components.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of a system to establish a physical sale of goods or services between a customer and a merchant;

FIG. 2 is an illustration of a system that utilizes a computing device to allow a customized merchant proposal to be accepted by a customer event request for proposal;

FIG. 3A is an illustration of a system with a software application for communication between a merchant mobile device and a customer mobile device;

FIG. 3B is an illustration of a software application that establishes communications for a physical sale of a customized good or service;

FIG. 4 is an illustration of a flow chart of an embodiment of a method establishing a sale between a merchant and a customer;

FIG. 5 is an illustration of a flow chart of an embodiment of a method communicating data between a computing device and at least one of a merchant mobile device and a customer mobile device;

FIG. 6 is an illustration of a flow chart of an embodiment of a method communicating data between a computing device and at least one of a merchant mobile device and a customer mobile device;

FIG. 7 is a schematic block diagram illustrating a suitable operating environment for aspects of the subject disclosure;

FIG. 8 is a schematic block diagram illustrating a suitable environment for delivery of data in accordance with the subject disclosure;

FIG. 9 is a schematic block diagram illustrating illustrates a cloud computing environment in accordance with the subject innovation;

FIG. 10 illustrates an example user interface displaying two different pending customer requests;

FIG. 11 illustrates an example user interface displaying a detailed view of a merchant response;

FIG. 12 illustrates an example user interface display of a booked request;

FIG. 13 illustrates an example user interface for merchant sorting and filtering;

FIG. 14 illustrates an example user interface displaying a detailed customer request available to the merchant.

### DETAILED DESCRIPTION

Embodiments of the innovation relate to methods and systems for a computing device that can be configured to manage communications between a merchant mobile device and a customer mobile device, wherein such communications can be utilized to communicate an event request for proposal to which a particular merchant can respond with a customized merchant proposal. The computing device and related communications afford one or more merchants to selectively respond to specific customer event requests as well as having the merchant responses be tailored to each customer event request. Upon a customer acceptance received from the customer mobile device, a portion of data can be delivered to the merchant or the computing device for status update of whether a merchant proposal has been redeemed, is pending, or is confirmed and accepted. In another embodiment, a customer can physically claim the merchant proposal with the merchant, wherein the merchant can enter a portion of data (e.g. access code, merchant ID, portion of text, alpha numeric entry, and the like) to represent a confirmation of a claimed merchant proposal from a customer. For instance, the confirmation of the claimed merchant proposal can be entered on the merchant mobile device or the customer mobile device. In general, the portion of data can be communicated to the merchant mobile device, the computing device, or the customer mobile device for a status of a received merchant proposal, wherein the status can be redeemed, pending, confirmed, and/or accepted. Additionally, an integrity score can be generated for each customer based on interactions (e.g., sales, offers, event request for proposals, reliability, etc.) with one or more merchants and/or reviews from one or more merchants.

With reference to the drawings, like reference numerals designate identical or corresponding parts throughout the several views. However, the inclusion of like elements in different views does not mean a given embodiment necessarily includes such elements or that all embodiments of the invention include such elements.

The term “merchant” as used herein can be defined as an entity that offers for sale at least one of a service or a good.

The term “customer” as used herein can be defined as an entity that purchases at least one of a service or a good from a merchant in exchange for money or an item with monetary value.

The term “mobile device” as used herein can be defined as a computing device having a display and the computing device is configured to transmit data or receive data. The term “mobile device” as used herein is not to be limited to being a device that is mobile but a computing device, mobile or non-mobile. By way of example and not limitation, the mobile device can be a smartphone, a cell phone, a tablet, a desktop machine, a portable gaming device, a gaming console, a laptop, a television with Internet connectivity, a computing device with Internet connectivity, among others.

The term “integrity score” as used herein can be defined as a generated rating for an account based on one or more reviews from one or more merchants. In an embodiment, the review from a customer can be related to a performance with a merchant that responded to an event request for proposal. In another embodiment, the review from a merchant can be related to a performance with a customer that accepted a merchant proposal.

The term “event request for proposal” as used herein can be defined as a request for solicitation from a customer communicated to one or more merchants for a specific event.

The term “merchant proposal” as used herein can be defined as a response (e.g., customized, exclusive, or tailored) by a merchant to an event request for proposal for a particular customer. In another embodiment, the “merchant proposal” can be a more general response by a merchant to two or more event request for proposals for more than one customer.

The term “module” as used herein can be defined as a portion of hardware, a portion of software, a portion of logic, a portion of or a combination thereof. A portion of hardware or a portion of logic can include at least a processor and a portion of memory, wherein the memory includes one or more instructions for execution.

The term “component” as used herein can be defined as a portion of hardware, a portion of software, or a combination thereof. A portion of hardware can include at least a processor and a portion of memory, wherein the memory includes an instruction to execute.

FIG. 1 illustrates a system 100 to establish a physical sale of goods or services between a customer and a merchant. The system 100 can include a computing device 102 that can receive and/or transmit data between at least one of a customer mobile device 106 or a merchant mobile device 108. The computing device 102 can include a software application 104. The software application 104 can execute on the computing device 102, on the customer mobile device 106, on the merchant mobile device 108, or a combination thereof.

The computing device 102 can manage communications between one or more merchant mobile devices 108 and one or more customer mobile devices 106, wherein such communications can be utilized to communicate an event request for proposal (from a customer mobile device) to which a particular merchant who can respond with a customized merchant proposal (from a merchant mobile device). The computing device 102 and related communications afford one or more merchants to selectively respond (via one or more merchant mobile devices 108) to specific customer event requests as well as having the merchant responses be tailored to each customer event request. Upon a customer acceptance of a merchant proposal, a customer can confirm acceptance in-person with the merchant at the merchant's place of business. For example, the merchant can confirm acceptance of the merchant proposal on the merchant mobile device 108. In another example, the merchant can confirm acceptance of the merchant proposal on the customer's device such as the customer mobile device 106. For instance, a portion of data can be communicated by the merchant to indicate a confirmed acceptance by a customer in-person in response to a merchant proposal. Moreover, a portion of data can be used to indicate a hold or pending status on a merchant proposal for a time upon acceptance of a merchant proposal by a customer to a later time upon in-person redemption of the merchant proposal to the merchant.

In another embodiment, upon a customer acceptance received from the customer mobile device 106, an acceptance code can be delivered to the merchant mobile device 108 for redemption of the merchant proposal. In another embodiment, upon customer accepted received from the customer mobile device 106, a portion of data can be communicated to the merchant mobile device 108 or the computing device 102 to indicate a status of the merchant proposal, wherein the status can be pending, accepted, confirmed, and/or redeemed. Moreover, the portion of data can be used to trigger an event such as a notification to a merchant. Additionally, the portion of data can be used to provide an indication of a status for the merchant proposal for the computing device 102, other customers, and/or other merchants.

It is to be appreciated that a customer can utilize the customer mobile device 106 to communicate with the computing device 102. Further, it is to be appreciated that a merchant can utilize a merchant mobile device 108 to communicate with the computing device 102. Still further, it is to be appreciated that one or more customer mobile devices 106 can communicate with the computing device 102 and that one or more merchant mobile devices 108 can communicate with the computing device 102. Yet, the computing device 102 can communicate one or more event requests for proposals from one or more customer mobile devices 106 based on a parameter.

In such example, the parameter can be identified or selected by one of the merchant mobile device 108 or the customer mobile device 106. For instance, the parameter can be, but is not limited to, a geographic location, a type of an event, a size of an event, a cost of an event, a criteria of the customer or guests of an event, a calendar or a schedule of a merchant, a calendar or a schedule of a customer, an availability on a calendar for a merchant or a customer, an availability for a venue of a merchant, among others.

In another embodiment, the parameter can be utilized to match a customer having an event request for proposal to a merchant based on a query of the merchant. In response to a query match to the query of the merchant, one or more results (e.g., one or more event request for proposals) can be communicated to the merchant in which the merchant can create a merchant proposal in response to satisfy the event request for proposal. In one example, the merchant proposal can be customized to a particular query match (e.g., one particular event request for proposal). In another example, the merchant proposal can be generalized for more than one query match (e.g., two or more event request for proposals). Thus, a set of the one or more merchant mobile devices 108 can receive the event requests for proposal which allows for a targeted delivery of such event requests for proposals, which in turn, allows for the set of the one or more merchant mobile devices 108 to customize a merchant proposal for each event request for proposal (if desired by the merchant utilizing the merchant mobile device 108).

The following is an example of the computing device 102 and the software application 104 processing data communications between the customer mobile device 106 and the merchant mobile device 108. A customer can access the computing device 102 and the software application 104 via a customer mobile device 106, wherein the access can be based upon visiting a website on the Internet, installing and executing the software application 104 or a portion thereof, among others. The customer can create an event request for proposal which can be delivered to one or more merchant mobile devices who have accessed the computing device 102 and/or the software application 104. For example, each merchant and each customer can have an account with the computing device 102 and/or the software application 104. Each merchant mobile device 108 can decide whether or not to reply to the event request for proposal in which the response would be either 1) no response as the merchant mobile device 108; 2) a merchant proposal specifically customized and tailored to the event request for proposal; or 3) a merchant proposal that is a general response to one or more event request for proposals from one or more customers. Each merchant proposal can be evaluated by the customer mobile device 106 and if desired, an acceptance can be communicated to the merchant mobile device 108 via the computing device 102 and/or software application 104. Upon receipt of the acceptance, the computing device 102 and/or software application 104 can generate a portion of data for the merchant mobile device 108 and/or the customer mobile device 106 that can be used to indicate a redemption by a customer of the merchant proposal.

In an embodiment, a number of event request for proposals and/or a number of merchant proposals can be throttled, limited, or managed. In particular, a merchant can receive a predefined allocation of merchant proposals for a defined period of time and an additional merchant proposal can be authorized upon confirmation of each acceptance from a customer of a communicated merchant proposal. In another embodiment, each merchant proposal and/or event request for proposal can be purchased from the computing device 102 via the merchant mobile device 108 or the customer mobile device 106.

In an embodiment, an integrity score can be utilized for a merchant or a customer based on one or more reviews related to use of the computing device 102 and/or software application 104. For instance, a merchant can be reviewed by one or more customers. In another instance, a customer can be reviewed by one or more merchants. In an embodiment, the review can correspond to a verification of whether the customer and/or merchant performed accordingly based on the customer acceptance of the merchant proposal (in response to the event request for proposal).

In an embodiment, the computing device 102 can collect data related to the merchant and/or customer for a respective account in order to tailor an experience with the computing device 102 and/or the software application 104. For example, the tailoring of the experience can be to help ensure the merchant proposal satisfies the needs, wants, and/or desires of the customer. For instance, profile data for each merchant and/or customer can be collected to enhance use of the system 100.

In an embodiment, upon receipt of a merchant proposal, the customer mobile device 106 can generate a counter proposal which can be communicated to the merchant mobile device 108. It is to be appreciated that one or more electronic communications can be sent and/or received between the merchant mobile device 108 and the customer mobile device 106 after a communication of a merchant proposal is sent (e.g., actively selected for sending) to the customer mobile device 106. Thus, a bartering or negotiation can be employed with the computing device 102 and/or the software application 104. In an embodiment, a communication channel or data channel can be established between a customer and a merchant based on a receipt of a merchant proposal and a user input from either the merchant or the customer. The communication channel or data channel can be used to exchange data (e.g., text, voice, audio, video, etc.) between the customer mobile device and the merchant mobile device to facilitate completion of a sale between the customer and merchant.

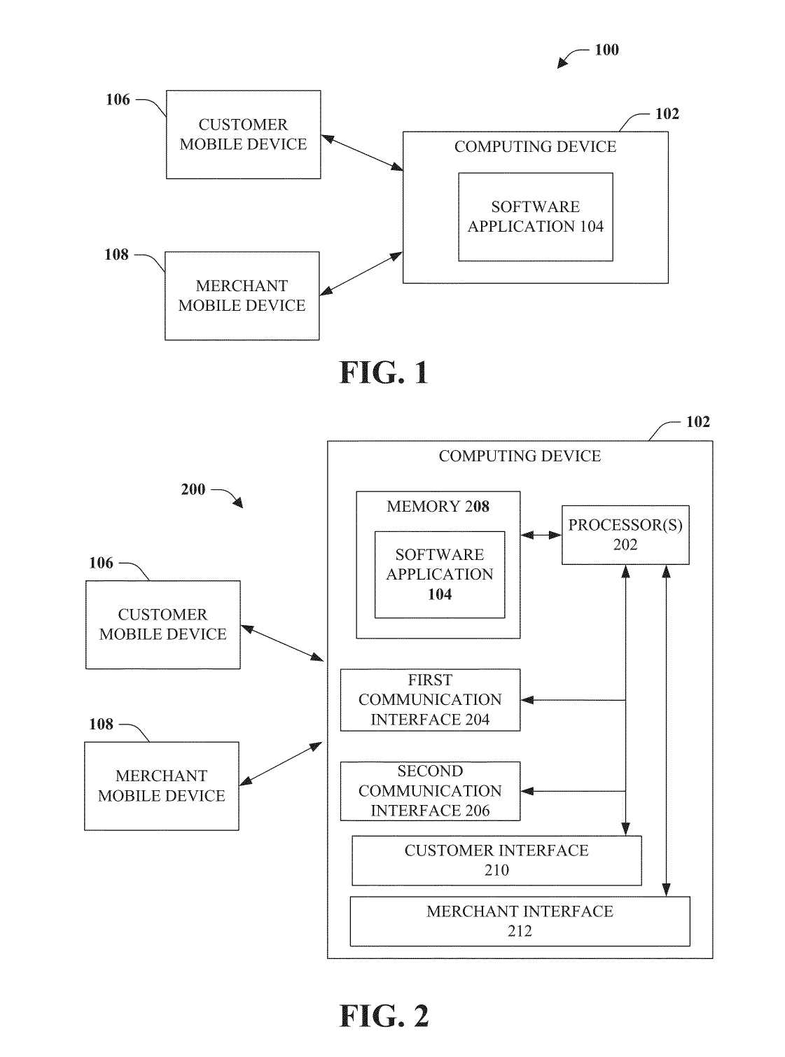

Turning to FIG. 2, a system 200 is illustrated utilizing the computing device 102 and the software application 104 to communicate data representative of at least one of an event request for proposal, a merchant proposal in response to the event request for proposal, an acceptance, or a portion of data indicative of redemption or status change of a merchant proposal between the customer mobile device 106 and the merchant mobile device 108. Computing device 102 includes one or more processor(s) 202 configured to execute computer-executable instructions such as instructions composing software application 104. Such computer-executable instructions can be stored on one or more computer-readable media including a non-transitory, computer-readable storage medium such as memory 208 of computing device 102.

Computing device 102 includes a first communication interface 204 and a second communication interface 206. As shown in FIG. 2, first communication interface 204 can enable and process electronic communications between the computing device 102 and the customer mobile device 106. It is to be appreciated that the first communication interface 204 can be a wired or wireless interface including, but not limited, a WiFi interface, an Ethernet interface, a fiber optic interface, a cellular radio interface, a satellite interface, an interface for the Internet, a LAN cable, an Ethernet cable, a USB interface, a serial interface, a WiFi interface, a short-range RF interface, Bluetooth®, , an infrared interface, a near-field communication (NFC) interface, a wireless connection, a wired connection, etc. Second communication interface 206 can enable and process electronic communications between the computing device 102 can the merchant mobile device 108. As such, second communication interface 206 can be a WiFi interface, an Ethernet interface, a fiber optic interface, a cellular radio interface, a satellite interface, an interface for the Internet, a LAN cable, an Ethernet cable, a USB interface, a serial interface, a WiFi interface, a short-range RF interface (Bluetooth), an infrared interface, a near-field communication (NFC) interface, etc. While shown separate in FIG. 2, first communication interface 204 and second communication interface 206 can be a single interface or an interface capable of simultaneous communication over multiple connections.

Computing device 102 can further include a customer interface 210 that comprises various elements to obtain data representative of customer input and to convey data representative of customer output. For instance, customer interface 210 can comprise a web interface or webpage that operates as both an input device and an output device. In addition, customer interface 210 can also include various buttons, switches, keys, a physical button or input, a digital representation of a button or input, a GUI, a web-based GUI, etc. by which a customer can input information to computing device 102, and other displays, LED indicators, etc. by which other information can be output to the customer.

Computing device 102 can further include a merchant interface 212 that comprises various elements to obtain data representative of merchant input and to convey data representative of merchant output. For instance, merchant interface 212 can comprise a web interface or webpage that operates as both an input device and an output device. In addition, merchant interface 212 can also include various buttons, switches, keys, a physical button or input, a digital representation of a button or input, a GUI, a web-based GUI, etc. by which a merchant can input information to computing device 102, and other displays, LED indicators, etc. by which other information can be output to the merchant.

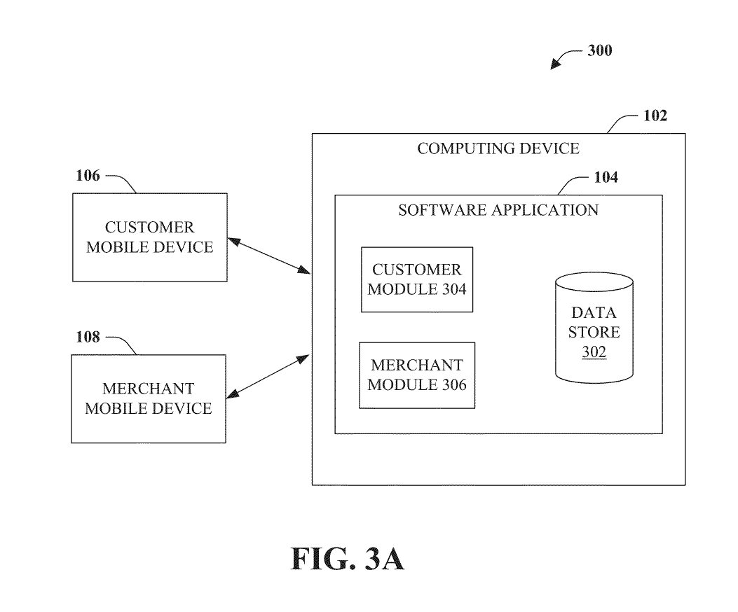

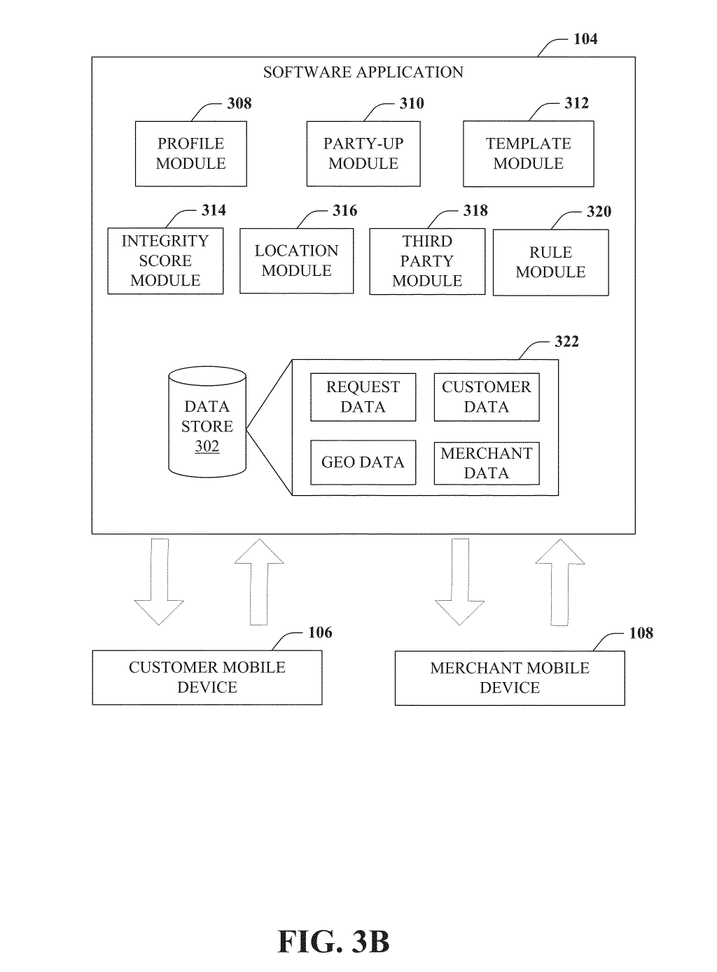

In accordance with an embodiment, computing device 102 is at least one of a computing device, a network, a server, a website, the software application 104 executed thereon, and the like. However, it is to be appreciated that the computing device 102 can be other portable form-factors such as a laptop computer, a convertible laptop, a cell phone, a PDA, a pocket computing device, a watch computing device, or the like. Moreover, it is to be appreciated that the functionality described herein with respect to the computing device 102 can be performed by a desktop computer, or other larger, less portable computing device. That is, software application 104 can be installed and executed on substantially any computing device provided that such a computing device can communicate with the customer mobile device 106 and/or the merchant mobile device 108 as described above and below with regard to FIGS. 1, 3A, and 3B. Although a single computing device 102 is illustrated in FIG. 2, it is to be appreciated that one or more computing devices 102 can be utilized with the subject innovation. For example, a first computing device can be employed to process communications with the customer mobile device 106, a second computing device can be employed to process communications with the merchant mobile device 108, and the first computing device and the second computing device can communicate between one another.

It is to be appreciated that the computing device 102 and/or the software application 104 can be a network or a portion of a network, wherein the network is at least one of a website, a server, a computer, a cloud-service, a processor and memory, or a computing device connected to the Internet and configured to transmit/receive data with at least one of the customer mobile device 106 or the merchant mobile device 108. In general, the network can be coupled to one or more devices via wired or wireless connectivity in which data communications are enabled between the network and at least one of a second network, a subnetwork of the network, or a combination thereof. It is to be appreciated that any suitable number of networks can be used with the subject innovation and data communication on networks can be selected by one of sound engineering judgment and/or one skilled in the art.

FIG. 3A illustrates a system 300 of the software application 104 that communicates data between the merchant mobile device 106 and the customer mobile device 108. The software application 104 can further include a data store 302, a customer module 304, and a merchant module 306.

It is to be appreciated that the data store 302 can be, for example, either volatile memory or nonvolatile memory, or can include both volatile and nonvolatile memory. The data store 302 of the subject systems and methods is intended to comprise, without being limited to, these and other suitable types of memory. In addition, it is to be appreciated that the data store 302 can be a server, a database, a hard drive, a flash drive, an external hard drive, a portable hard drive, a cloud-based storage, a solid state drive, and the like.

The data store 302 can store data utilized by the software application 104, communicated between the computing device 102 and the customer mobile device 106, communicated between the computing device 102 and the merchant mobile device 108, communicated between the computing device 102 and another component or device, and/or any combination thereof. Further, it is to be appreciated that the software application 104 can be a stand-alone application on the computing device 102, integrated into the customer mobile device 106, integrated into the merchant mobile device 108, hosted by a server, hosted by a network, and/or any combination thereof.

The customer module 304 is configured to process data communications between the customer mobile device 106 and the computing device 102 and/or between the customer mobile device 106 and the merchant mobile device 108. For example, a customer can utilize the customer mobile device 106 and in turn the customer module 304 via the data received by a user interface of the customer mobile device 106. The customer module 304 can receive data from the customer mobile device 106 and create an event request for proposal. Moreover, the customer module 304 can manage an account for the customer mobile device 106 and data related thereto such as, but not limited to, customer input to communicate data related to an account, customer information, geographic location, customer personal tastes, customizable data defined by an administrator of the computing device 102 in which such data is to be provided by a customer, customer review data of a merchant, an acceptance, and the like.

The merchant module 306 is configured to process data communications between the merchant mobile device 108 and the computing device 102 and/or between the merchant mobile device 108 and the customer mobile device 106. For example, a merchant can utilize the merchant mobile device 108 and in turn the merchant module 306 via the data received by a user interface of the merchant mobile device 108. The merchant module 306 can receive data from the merchant mobile device 108 and create a merchant proposal that is customized for a merchant selected or identified event request for proposal. Moreover, the merchant module 306 can manage an account for the merchant mobile device 108 and data related thereto such as, but not limited to, merchant input to communicate data related to an account, merchant information, geographic location, merchant desired customers, customizable data defined by an administrator of the computing device 102 in which such data is to be provided by a merchant, merchant review data of a customer, an acceptance code, an acceptance instruction, and the like.

FIG. 3B illustrates a block diagram of an exemplary, non-limiting embodiment of software application 104 according to one or more aspects. The software application 104 comprises computer-executable instructions and computer-readable data stored, for example on memory 208 (as shown in FIG. 2), of computing device 102 (as shown in FIG. 2). The computer-executable instructions of software application 104 are executable by processor 202 (as shown in FIG. 2) of computing device 102 (as shown in FIG. 2).

As shown in FIG. 3B, software application 104 can include profile module 308, party-up module 310, template module 312, integrity score module 314, location module 316, third party module 318, rule module 320 (collectively referred to as “the modules”) and support data 322 stored in the data store 302. The modules include computer-executable instructions implementing various features, processes, operations, etc. of software application 104.

Profile module 308 provides administration functions, configuration of software application 104, or the like. For example, profile module 308 enables administration (e.g., retrieval, display, and editing) of user profiles for customers and/or merchants, accounts, integrity scores, and/or settings or configurations related to the software application 104. The profile module 308 can further record preferences including, but not limited to, likes, dislikes, desires, wants, needs, interests, cravings, demographic groups, and the like. For instance, a preference for a particular good or service can be recorded. In another embodiment, the profile module 308 can record merchant data such as features, capabilities, demographic specifications, target groups, and the like. In addition, profile module 308 enables registration of customer mobile devices 106 and/or merchant mobile devices 108 with application software 104 and configuration of other information such as, but not limited to, payment information. Further, the profile module 308 can require the software application 104 to periodically check-in with the merchant mobile device 108 or the customer mobile device 106 to verify the account is valid, and for instance, subscription is paid. In another embodiment, the profile module can require the software application 104 to periodically check-in with the merchant mobile device 108 or the customer mobile device 106 to verify a valid payment method exists, payment information is accurate, and/or is up to date.

The party-up module 310 can allow the customer mobile device 106 to designate an event request for proposal as either a public event or a private event, wherein the private event is a default setting and invitees are by invite from a creator of the event request for proposal only. In a public event, the software application 104 can communicate the event request for proposal to additional customer mobile devices (e.g., based on geographic location, relationship on a social website, invitation by a creator of the invite, previous invitations, and the like) in which the additional customer mobile devices can “opt-in” to the public event request for proposal. The opt-in can be via the software application 104 and/or another website or application such as, but not limited to, a social website, a social media website, a social media application, and the like. Due to the increased number of customers, the consumer purchase power can be increased to persuade a merchant mobile device to communicate a more beneficial merchant proposal.

Template module 312 can be managed by an administrator of the software application 104 in which one or more templates can be provided to enable a customer to create an event request proposal or enable a merchant to create a merchant proposal. In particular, a merchant can create a custom and tailored merchant proposal and save a portion of such data as a template for future merchant proposals so the merchant need not create the merchant proposal from scratch. In another example, the software application 104 can provide templates to customers based on events or type of events which can be used to create an event request for proposal. In another example, the software application 104 can enable a customer to create customer-defined templates for an event request for proposal.

Integrity score module 314 can receive data related to one of a customer or a merchant to create an integrity score or ranking which is reflective of opinions the customer or the merchant received. In particular, the data can be a written review, a score on a scale, or any other data representative of an experience or opinion of a merchant or a customer. In particular, an integrity score can be generated for a customer based on a review or data collected by a merchant to which his or her merchant proposal was accepted. The integrity score can be defined by the software application 104 and can be a questionnaire, a series of questions, a grading, and the like. In another embodiment, the integrity score can be generated for a merchant based on a review or data collected by a customer to which he or she received a merchant proposal (that was accepted or not accepted). In another embodiment, the review can be related to a verification of whether the customer and/or merchant performed accordingly based on the customer acceptance of the merchant proposal (in response to the event request for proposal) in which the performance is, for instance, whether the customer physically showing up for an appointment based on an accepted merchant proposal, whether the merchant honors the merchant proposal, whether the merchant proposal is met on all conditions, among others. In another embodiment, the subject innovation can include digital badges or data images associated with accomplishments or relationships created between a customer and a merchant. The digital badge or data image can be a graphic, a portion of text, a logo, a GIF, a portion of audio, a portion of video, a combination thereof, among others.

Location module 316 can utilize an address input by the customer, an address input by the merchant or a specific location generated through self-locating mechanisms of the customer mobile device 106 or merchant mobile device 108 to provide location-based functionality. A location, whether a mailing address, triangulated position, global position, or the like, is maintained by location module 316 and can be a parameter for communicating an event request for proposal or a parameter for communicating a merchant proposal. For example, a location of a customer can be a parameter, associated or stored on the profile module 308, on which to base which merchant mobile devices 108 can receive an event request for proposal. In another example, a location of the merchant mobile device 108 can be communicated to the customer mobile device 106 in order to provide directions or indication of geographic location. It is to be appreciated that multiple locations or types of location can be maintained. For instance, one location maintained can be a customer location specific to a customer, such as a mail address. Another location maintained can be a dynamic location related to the customer mobile device 106. For instance, one location maintained can be a merchant location specific to a merchant, such a mail address. Another location maintained can be a dynamic location related to the merchant mobile device 108. For example, a dynamic location can be indicative of a merchant that is not in a fixed location such as a food truck, a pop-up stand for goods or services, a vendor, a public event, a concert, among others.

According to an aspect, location module 316 enables a customer to communicate a location of a potential upcoming event or an event in real time via the customer mobile device 106. That is, the software application 104, utilizing the location(s) maintained by the location module 316, can identify a location of the customer mobile device 106 for inclusion on an event request for proposal that is communicated. Moreover, such location can be a parameter in which one or more merchant mobile devices 108 can be selected for receipt due to geographic proximity. In another example, a location of a merchant and/or customer can be used to filter and/or match a customer and a merchant.

Third party module 318 can provide plug-in capabilities with at least one of a website, an application, a network, a device, a server, and the like. For example, the software application 104 can be utilized with a social media website or social media application. In another example, the third party module 318 can be hosted or executed by a social media website or social media application. For example, a social media website or social media application can be used to get data from, send data/updates to, and/or for technical connections (e.g., hospitality, connection/integration to point-of-service, reservation, inventory management systems, among others). Thus, it is to be appreciated that the software application 104 can be extended to at least one of a platform, a website, a server, a network, and the like that is owned by an entity different that an owner of the computing device 102 and/or the software application 104.

Rule module 320 can provide one or more rules defined by a merchant or customer in which upon satisfaction of a rule, an automated response can be triggered. For example, a merchant can establish a rule with rule module 320 in which a parameter or set of parameters for an event request for proposal can be defined and if satisfied, a particular merchant proposal can be communicated to that event request for proposal. Moreover, the rule can allow a template or a pre-defined merchant proposal to be communicated to the customer who communicated the event request for proposal. In another example, a customer can establish a rule with rule module 320 in which a parameter or set of parameters can be defined for a merchant proposal (that is in response to an event request for proposal from the customer) and if satisfied, merchant proposals can be filtered accordingly.

In still another embodiment, the rule module 320 can evaluate an event request for proposal from a customer and identify a follow up question to communicate to the customer, wherein an answer to the follow up question can glean insight on providing a good or service more to the liking or desire of the customer. In still another embodiment, the rule module 320 can evaluate a merchant proposal from a merchant and identify a follow up question to communicate to the merchant, wherein an answer to the follow up question can glean insight on providing an offer for a good or service more to the liking or desire of the customer.

As shown in FIG. 3B, software application 104 includes various support data 322. Support data 322 includes event request for proposal data, account data, customer data, merchant data, geographic data, and the like. According to an embodiment, multiple users (e.g., customers and/or merchants) can utilize software application 104 by maintaining separate accounts or profiles. Each user is provided access to software modules according to his or her account

The aforementioned systems, devices, applications, modules, components, (e.g., computing device 102, software application 104, customer mobile device 106, merchant mobile device 108, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

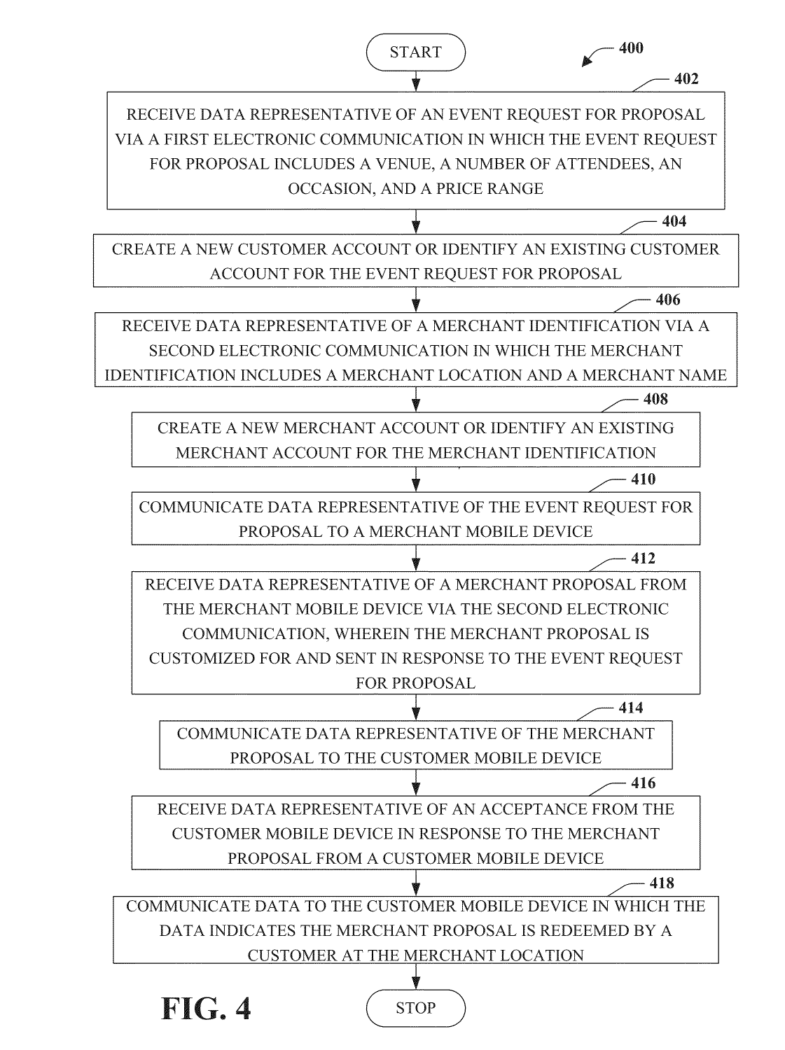

In view of the exemplary devices and elements described supra, methodologies that may be implemented in accordance with the disclosed subject matter will be better appreciated with reference to the flow charts of FIGS. 4-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 4 illustrates a method 400 for establishing a sale between a merchant and a customer based on an event request for proposal that is selectively responded to by a merchant. At reference numeral 402, data representative of an event request for proposal can be received via a first electronic communication in which the event request for proposal includes, for example, a venue, a number of attendees, an occasion, or a price range. At reference numeral 404, a new customer account can be created or an existing customer account can be identified for the event request for proposal. In an example, data representative of the new account or the existing account can be stored and data representative of the event proposal request can be stored. At reference numeral 406, data representative of a merchant identification can be received via the second electronic communication in which the merchant identification includes a merchant location and a merchant name.

At reference numeral 408 a new merchant account can be created or an existing merchant account can be identified for the merchant identification. At reference numeral 410, data representative of the event request for proposal can be communicated to the merchant mobile device. At reference numeral 412, data representative of a merchant proposal can be received from the merchant mobile device via the second electronic communication, wherein the merchant proposal is customized for and sent in response to the event request for proposal. At reference numeral 414, data representative of the merchant proposal can be communicated to the customer mobile device. At reference numeral 416, data representative of an acceptance can be received from the customer mobile device in response to the merchant proposal from the customer mobile device. At reference numeral 418, data can be communicated to the customer mobile device in which the data indicates the merchant proposal is redeemed by a customer at the merchant location.

For example, upon a customer acceptance of a merchant proposal, a customer can confirm acceptance in-person with the merchant at the merchant's place of business. For example, the merchant can confirm acceptance of the merchant proposal on the merchant mobile device. In another example, the merchant can confirm acceptance of the merchant proposal on the customer's device such as the customer mobile device. For instance, a portion of data can be communicated by the merchant to indicate a confirmed acceptance by a customer in-person in response to a merchant proposal. Moreover, a portion of data can be used to indicate a hold or pending status on a merchant proposal for a time upon acceptance of a merchant proposal by a customer to a later time upon in-person redemption of the merchant proposal to the merchant.

In another embodiment, upon a customer acceptance received from the customer mobile device, an acceptance code can be delivered to the merchant mobile device 108 for redemption of the merchant proposal. In another embodiment, upon customer accepted received from the customer mobile device, a portion of data can be communicated to the merchant mobile device or the computing device to indicate a status of the merchant proposal, wherein the status can be pending, accepted, confirmed, and/or redeemed. Moreover, the portion of data can be used to trigger an event such as a notification to a merchant. Additionally, the portion of data can be used to provide an indication of a status for the merchant proposal for the computing device 102, other customers, and/or other merchants.

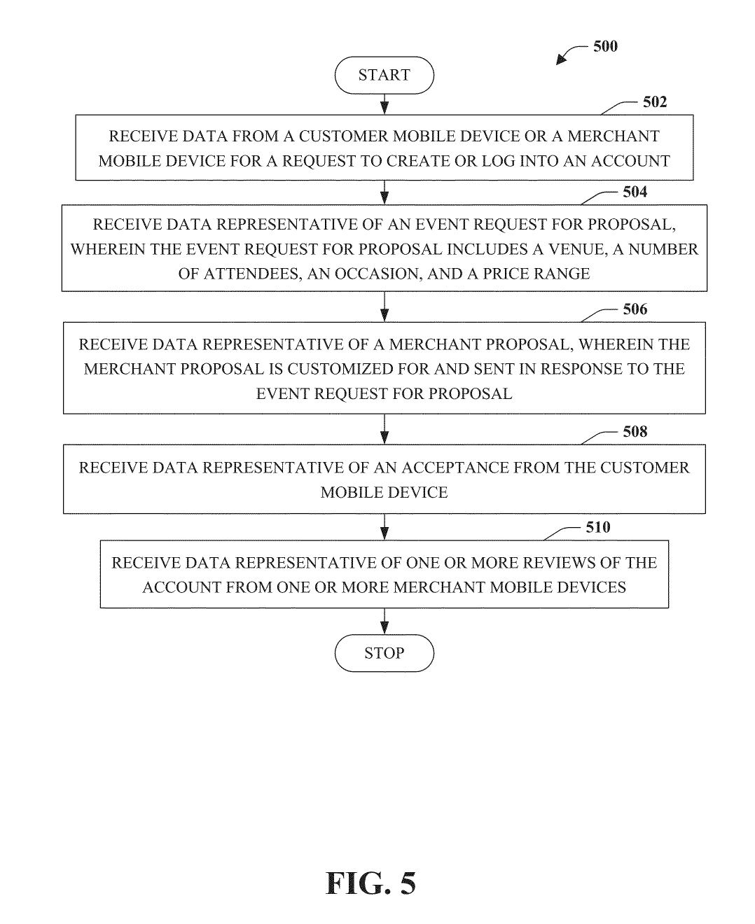

FIG. 5 illustrates a method 500 for data communications for the computing device and, in particular, for data received by the computing device. At reference numeral 502, data can be received from a customer mobile device or a merchant mobile device for a request to create or log into an account. At reference numeral 504, data representative of an event request for proposal can be received, wherein the event request for proposal includes a venue, a number of attendees, an occasion, and a price range. At reference numeral 506, data representative of a merchant proposal can be received, wherein the merchant proposal is customized for and sent in response to the event request for proposal. At reference numeral 508, data representative of an acceptance can be received from the customer mobile device. At reference numeral 510, data representative of one or more reviews of the account can be received from one or more merchant mobile devices.

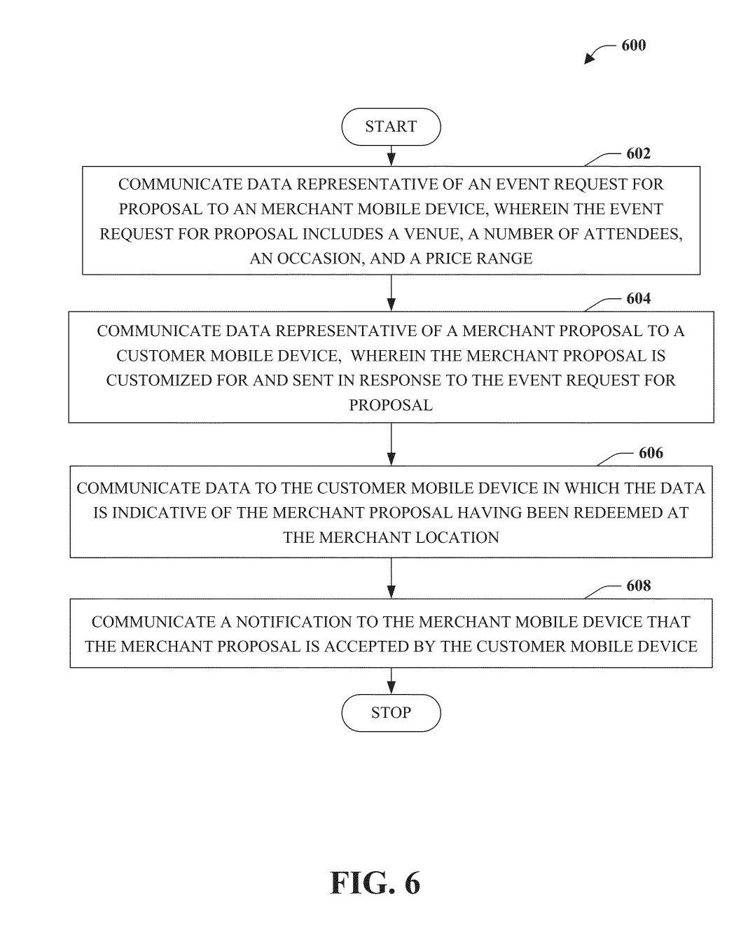

FIG. 6 illustrates a method 600 for data communications for the computing device and, in particular, for data communicated by the computing device. At reference numeral 602, data representative of an event request for proposal can be communicated to a merchant mobile device, wherein the event request for proposal includes a venue, a number of attendees, an occasion, and a price range. At reference numeral 604, data representative of a merchant proposal can be communicated to a customer mobile device, wherein the merchant proposal is customized for and sent in response to the event request for proposal. At reference numeral 606, data can be communicated to the customer mobile device in which the data is indicative of the merchant proposal having been redeemed at the merchant location. At reference numeral 608, data representative of a notification can be communicated to the merchant mobile device that the merchant proposal is accepted by the customer mobile device. In another embodiment, a dashboard can be provided that is a user interface that illustrates data graphically to a user on a display of a computing device, wherein the data can be for a customer and/or a merchant. In an example, a dashboard can graphically display data for a merchant and/or a customer such as, but not limited to, an event request for a proposal, a merchant proposal, a status of an event request for a proposal, a status of a merchant proposal, a confirmation of an acceptance of a merchant proposal, a list of merchants, a list of customers, a profile of a merchant, a profile of a customer, among others. For example, the dashboard can include tabs or icons for various categories of data represented graphically.

As used herein, the terms “component,” “module,” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

It is to be appreciated that an “application” can include one or more modules that perform one or more functionalities via instructions stored on a memory executed by a processor. Moreover, although a module and functionality may be described as a single module, it is to be appreciated that modules and respective functionalities can be combined into two or more modules. Additionally, one or more applications can be provided to include the one or more modules described herein. For example, the software application 104 can be comprised of one or more applications that perform the functionalities described herein, wherein the one or more applications include one or more of the modules described herein.

It is to be appreciated that the “application” (here the software application 104) can be hosted in a cloud, on a mobile device, on a server, on a computing device (e.g., computing device 102, a server, a network, a website, and the like), and/or a combination thereof. Moreover, although a single processor and/or memory is illustrated, it is to be appreciated that one or more processors and/or one or more memory can be employed with the subject innovation.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

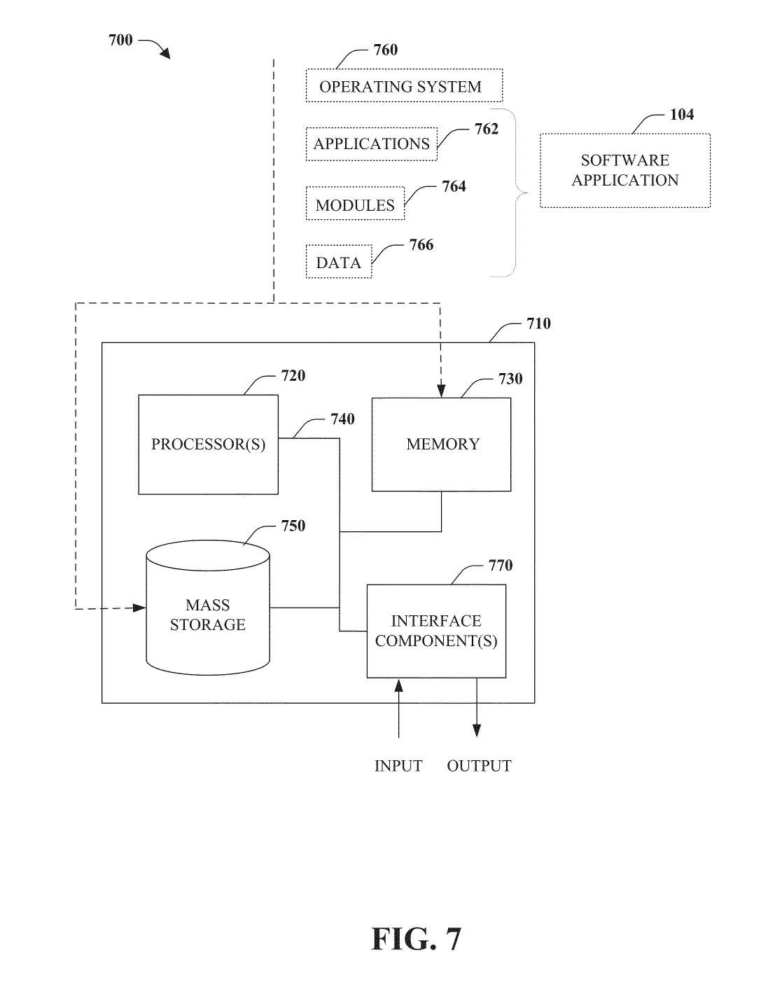

In order to provide a context for the claimed subject matter, FIG. 7 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), portable gaming device, smartphone, tablet. Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 7, illustrated is an example general-purpose computer 710 or computing device (e.g., desktop, laptop, server, hand-held, programmable consumer or industrial electronics, set-top box, game system . . . ). The computer 710 includes one or more processor(s) 720, memory 730, system bus 740, mass storage 750, and one or more interface components 770. The system bus 740 communicatively couples at least the above system components. However, it is to be appreciated that in its simplest form the computer 710 can include one or more processors 720 coupled to memory 730 that execute various computer executable actions, instructions, and or components stored in memory 730.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration.

The computer 710 can include or otherwise interact with a variety of computer-readable media to facilitate control of the computer 710 to implement one or more aspects of the claimed subject matter. The computer-readable media can be any available media that can be accessed by the computer 710 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 710.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 730 and mass storage 750 are examples of computer-readable storage media. Depending on the exact configuration and type of computing device, memory 730 may be volatile (e.g., RAM), non-volatile (e.g., ROM, flash memory . . . ) or some combination of the two. By way of example, the basic input/output system (BIOS), including basic routines to transfer information between elements within the computer 710, such as during start-up, can be stored in nonvolatile memory, while volatile memory can act as external cache memory to facilitate processing by the processor(s) 720, among other things.

Mass storage 750 includes removable/non-removable, volatile/non-volatile computer storage media for storage of large amounts of data relative to the memory 1030. For example, mass storage 750 includes, but is not limited to, one or more devices such as a magnetic or optical disk drive, floppy disk drive, flash memory, solid-state drive, or memory stick.

Memory 730 and mass storage 750 can include, or have stored therein, operating system 760, one or more applications 762, one or more program modules 764, and data 766. The operating system 760 acts to control and allocate resources of the computer 710. Applications 762 include one or both of system and application software and can exploit management of resources by the operating system 760 through program modules 764 and data 766 stored in memory 730 and/or mass storage 750 to perform one or more actions. Accordingly, applications 762 can turn a general-purpose computer 710 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the software application 104 (associated functionality, modules, and/or portions thereof) can be, or form part, of an application 762, and include one or more modules 764 and data 766 stored in memory and/or mass storage 750 whose functionality can be realized when executed by one or more processor(s) 720. Moreover, it is to be appreciated that the software, firmware, or combination thereof to perform the functionality of the described components herein can be downloaded, installed, or a combination thereof from any host. For instance, the host can be an online store, a website, an IP address, an application store, a network, a storage medium, a portable hard disk, a server, or the Internet.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the software application 104 (associated functionality, modules, and/or portions thereof) can be embedded within hardware in a SOC architecture.

The computer 710 also includes one or more interface components 770 that are communicatively coupled to the system bus 740 and facilitate interaction with the computer 710. By way of example, the interface component 770 can be a port (e.g., serial, parallel, PCMCIA, USB, FireWire . . . ) or an interface card (e.g., sound, video . . . ) or the like. In one example implementation, the interface component 770 can be embodied as a user input/output interface to enable a user to enter commands and information into the computer 710 through one or more input devices (e.g., pointing device such as a mouse, trackball, stylus, touch pad, keyboard, microphone, joystick, game pad, satellite dish, scanner, camera, other computer . . . ). In another example implementation, the interface component 770 can be embodied as an output peripheral interface to supply output to displays (e.g., CRT, LCD, plasma . . . ), speakers, printers, and/or other computers, among other things. Still further yet, the interface component 770 can be embodied as a network interface to enable communication with other computing devices (not shown), such as over a wired or wireless communications link.

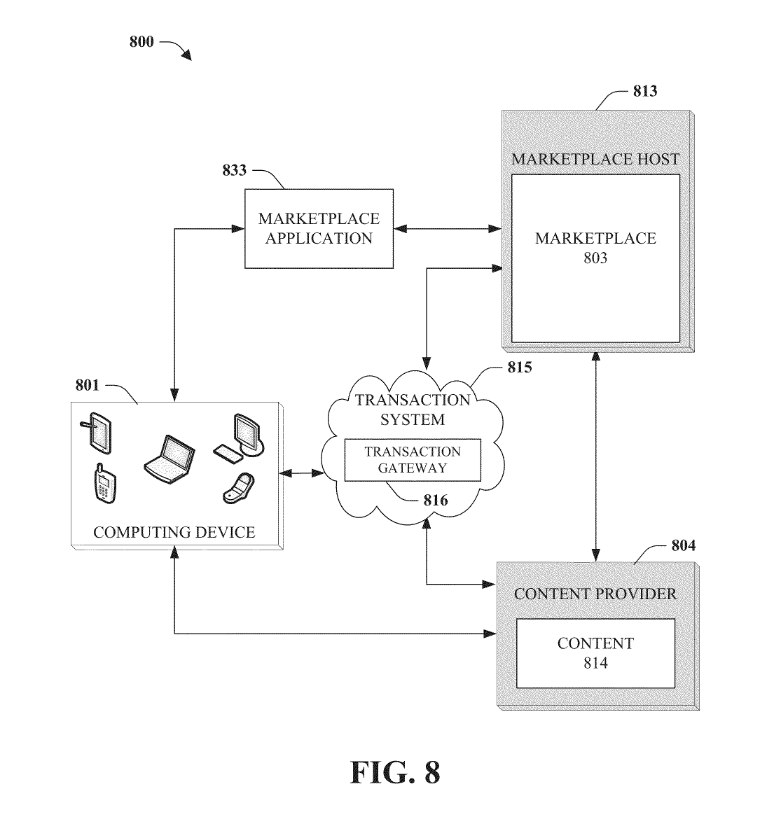

FIG. 8 illustrates an operating environment 800 that can be used with the subject innovation and in particular, the software application 104. The operating environment 800 includes a computing device 801 (e.g., device smartphone, a tablet, a laptop, a desktop machine, a portable gaming device, a device with Internet connectivity, among others), a user, a marketplace 803, a content provider 804, and content 814. The operating environment 800 is configured to deliver data (e.g., content 814) to the computing device 801 based upon a request from the computing device 801 (e.g., typically initiated by a user of the computing device 801). However, it may be appreciated that the delivery of data to the computing device 801 can be pushed to the computing device 801 and further approved (e.g. acceptance of license agreement, among others) by the user. The data delivered can be from a content provider 804, wherein the data can be delivered directly to the computing device 801 or indirectly delivered to the computing device 801 via the marketplace 803 and/or the marketplace applications 833. In an embodiment, the computing device 801 can utilize a transaction system 815 that facilitates purchasing data via at least one of the marketplace 803, the marketplace applications 833, the content provider 804, and the like. The transaction system 815 can be configured to utilize a transaction gateway 816 to facilitate completing a transaction between entities (e.g., user, content provider, marketplace, among others).

The computing device 801 and the marketplace 803 can be configured to communicate across a network, for example, wherein the marketplace 803 is accessed via the marketplace application 833 or a user interface (UI) associated with one of the marketplace 803 or the marketplace host 813. The marketplace 803 can be hosted by a marketplace host 813 associated with any suitable host, server, computer, data store, and the like.

In one embodiment, the computing device 801 is mobile so that it may function for a period of time without requiring a physical connection to a power source or network provider. For example, a cellular network or a Wi-Fi connection can be used by the computing device 801 in order to transmit and/or receive data within the operating environment 800.

A user can employ the computing device 801 for the device's intended functions as well as communicating data with the marketplace 803 and/or marketplace host 813. Commonly, the user purchases content 814 and/or products from the content provider 804 via the transaction system 815. It is to be appreciated that the marketplace 803 can be in an electronic form such as a website, the marketplace application 833, or an executable program. In a preferred embodiment, the marketplace 803 takes the form of the marketplace application 833 configured to run on the user's computing device 801. The marketplace application 833 may be utilized to install the content 814 from the content provider 804 onto the computing device 801.

The marketplace 803 can further connect the content provider 804 and/or the content 814 of the content provider 804 with the computing device 801 to allow the user to receive content 814 via a download (e.g., communication of data packets). The marketplace 803 can offer the user a variety of content 814 for purchase (via the transaction system 115) or for free of charge. The content 814 offered by the marketplace 803 may also come from the marketplace host 813. For example, the content provider 804 can have a website for direct delivery of content 814 or have content 814 hosted in the marketplace 803 by the marketplace host 813. Thus, in such an example, a user can directly receive data or content from the website of the content provider 804 or use the marketplace application 833 to identify the content 814 for receipt through the marketplace 803. Moreover, the content 814 can be tailored to the computing device 801. For instance, a first content can be built for a first computing device having a first operating system and a second content can be built for a second computing device having a second operating system, wherein the first content and the second content can be from the content provider 804.

In some embodiments, the system 800 utilizes the transaction system 815. The transaction system 815 can include a transaction gateway 816 that facilitates transactions between at least the marketplace host 813, one or more users, the marketplace 803, and/or the content provider 804. When the user purchases content 814 from the marketplace 803 or content provider 804, a transaction gateway 816 can receive a request to apply a charge to a user account (e.g., a monetary value via an electronic transaction via an account) owned or authorized by the user. For example, the user account can be, but is not limited to being, a credit card account, an account with the content provider 804 or marketplace host 813, a bank account, a debit account, an e-commerce account (e.g. Pay-Pal®), an electronic account, a savings account, and the like.

The transaction gateway 816 can store transaction data (e.g., user account, username, password, data related to the user, data related to the computing device 801, among others) specific to a transaction to receive content 814. The transaction gateway 816 can further collect and/or store data regarding one or more users, wherein the data can be, but is not limited to, credit card numbers, to make it easier for the one or more users to engage in multiple transactions (e.g., simultaneously and/or various points in time). The transaction gateway 816 can further reverse a transaction between one or more parties involved, such as providing a refund to the user.

It is to be appreciated that a purchase may not require the transfer of finances. For example, the content 814 on the marketplace 803 could be free to download. Additionally, a portion of the transaction system 815 can be integrated into at least one of the content provider 804, the marketplace host 813, the marketplace application 833, or a combination thereof. In another embodiment, the first content 814 can be free but additional content related to the first content 814 can require a purchase.

The content provider 804 can create content 814 (e.g., also referred to as products, software, apps, applications, and the like) that can be sold on the marketplace 803. By way of example and not limitation, the content provider 804 can be a videogame company that creates a game to be made available for download from the marketplace 803. By way of another example and not limitation, a bank can develop a mobile banking application that is communicated to the marketplace 803 and made available for download via the marketplace 803. In such example, the bank is the content provider 804. Additionally, the bank may host the mobile banking application on the bank's website for download or delivery to users. It is to be appreciated and understood that the content provider 804 is not limited to these examples and the content provider 804 can be any suitable entity (e.g., user, company, business, group of users, and the like) that creates or develops content 814 to be distributed to the marketplace host 813 for download via the marketplace 803.

The marketplace host 813 maintains the marketplace 803 on a network. The marketplace host 813 owns and/or controls a host server that contains the marketplace 803, and provides the user access to the marketplace 803. The marketplace host 813 can further control an amount of bandwidth allocated to the user to download the content 814 of the one or more content providers 804. In a non-limiting embodiment, the marketplace host 813 can own and/or control the marketplace 803. In another non-limiting embodiment, the marketplace host 813 can host the marketplace 803 on a network to enable access by the user.

In an exemplary embodiment, a user accesses the marketplace 803 via the marketplace application 833 located on the computing device 801. The computing device 801 can have access to the network 805, and the computing device 801 can communicate data in the form of a query to the marketplace host 813, wherein the data can be a request for information on content 814. The marketplace host 813 can communicate data in the form of a query result (which can include content 814) via a network to the computing device 801 for review, install, use, storage, and the like. In a non-limiting embodiment, the computing device 801 can include a user-interface that displays the data (e.g., the query, the query result, the content 814, among others) for the user.

Prior to download of content 814, the user can further navigate information regarding the content 814 that is displayed and select to either request additional content 814 or to purchase the content 814. If the user selects to purchase content 814, the marketplace application 833 communicates a purchase request to the marketplace host 813. The marketplace host 813 can then use the transaction system 815 which includes the transaction gateway 816 charging the user account if data related to the user account is available, and if the user account is not available, then the marketplace host 813 can request user account 812 information from the user which can then be sent to the transaction gateway 816. Upon receipt of the user account information, the transaction gateway 816 can charge the user account, and send a confirmation of the transaction back to the marketplace host 813.

The marketplace host 813 can then communicate the confirmation information to the computing device 801, as well as enable the user to download data for the content 814 and/or the marketplace application 833 stored in a host server regarding the specific content 814 and/or marketplace application 833 purchased. The marketplace application 833 can further assist with installation of the content 814 or marketplace application 833 purchased onto the computing device 801. It is to be appreciated and understood that the above process can occur in any order, such as a downloading of application information from the marketplace host 813 prior to the transaction and the order of the above described process is not to be limiting on the subject innovation.

One of ordinary skill in the art can appreciate that the various embodiments of system that provides a service through, for example, software, described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not limited to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the system that provides a service through, for example, software can be implemented based on such a cloud environment. For example, the software application 104 (as seen in previous figures) can reside in the cloud environment such that the computer-executable instruction implementing the functionality thereof are executed with the aggregated computing resources provided by the plurality of physical computing devices. The cloud environment provides one or more methods of access to the subject innovation, which are utilized the software application 104. In an embodiment, software and/or a component can be installed on a mobile device to allow data communication between the mobile device and the cloud environment. These methods of access include IP addresses, domain names, URLs, etc. Since the aggregated computing resources can be provided by physical computing device remotely located from one another, the cloud environment can include additional devices such as a routers, load balancers, switches, etc., that appropriately coordinate network data.

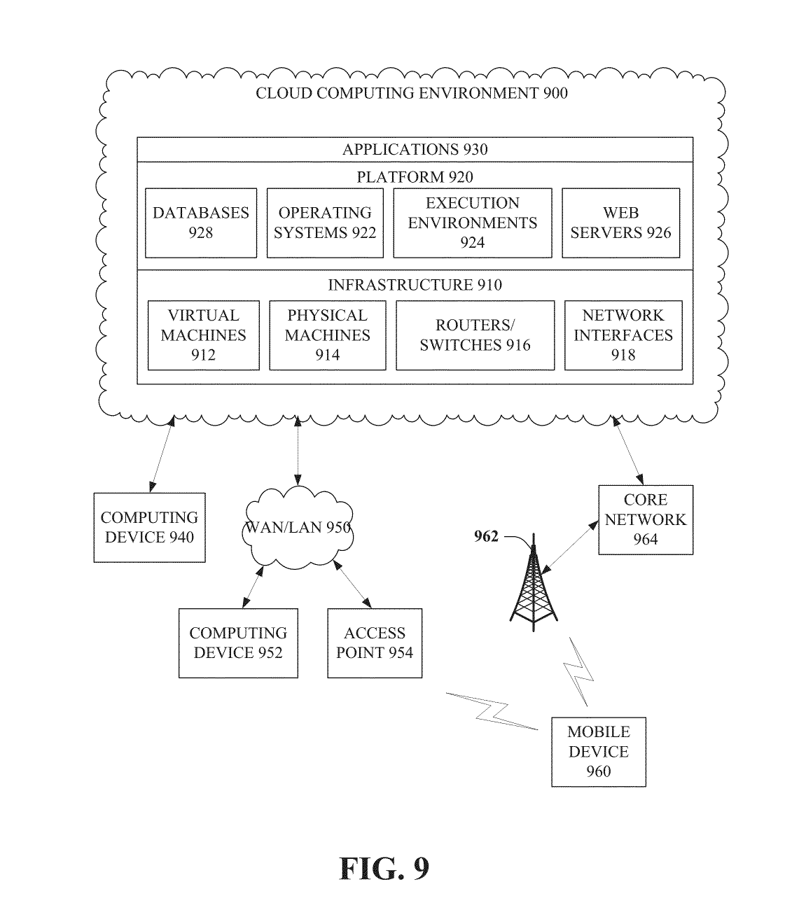

FIG. 9 provides a schematic diagram of an exemplary networked or distributed computing environment, such as a cloud computing environment 900. The cloud computing environment 900 represents a collection of computing resources available, typically via the Internet, to one or more client devices. The cloud computing environment 900 comprises various levels of abstraction: infrastructure 910, a platform 920, and applications 930. Each level, from infrastructure 910 to applications 930 is generally implemented on top of lower levels, with infrastructure 910 representing the lowest level.

Infrastructure 910 generally encompasses the physical resources and components on which cloud services are deployed. For instance, infrastructure 910 can include virtual machines 912, physical machines 914, routers/switches 916, and network interfaces 98. The network interfaces 98 provide access to the cloud computing environment 900, via the Internet or other network, from client devices such as computing devices 940, 952, 960, etc. That is, network interfaces 98 provide an outermost boundary of cloud computing environment 900 and can couple the cloud computing environment 900 to other networks, the Internet, and client computing devices. Routers/switches 916 couple the network interfaces 98 to physical machines 914, which are computing devices comprising computer processors, memory, mass storage devices, etc. Hardware of physical machines 914 can be virtualized to provide virtual machines 912. In an aspect, virtual machines 912 can be executed on one or more physical machines 914. That is, one physical machine 914 can include a plurality of virtual machines 912.

Implemented on infrastructure 910, platform 920 includes software that forming a foundation for applications 930. The software forming platform 920 includes operating systems 922, programming or execution environments 924, web servers 926, and databases 928. The software of platform 920 can be installed on virtual machines 912 and/or physical machines 914.

Applications 930 include user-facing software applications, implemented on platform 920, that provide services to various client devices. In this regard, the software application 104 described herein is an example application 930. As illustrated in FIG. 9, client devices can include computing devices 940, 952 and mobile device 960. Computing devices 940, 952 can be directly coupled to the Internet, and therefore the cloud computing environment 900, or indirectly coupled to the Internet via a WAN/LAN 950. The WAN/LAN 950 can include an access point 954 that enables wireless communications (e.g., WiFi) with mobile device 960. In this regard, via access point 954 and WAN/LAN 950, mobile device 960 can communicate wirelessly with the cloud computing environment 900. Mobile device 960 can also wirelessly communicate according to cellular technology such as, but not limited to, GSM, LTE, WiMAX, HSPA, etc. Accordingly, mobile device 960 can wireless communicate with a base station 962, which is coupled to a core network 964 of a wireless communication provider. The core network 964 includes a gateway to the Internet and, via the Internet, provides a communication path to the cloud computing environment 900.

In an embodiment, the software application can be configured such that a user account can be both a customer account and a merchant account. For example, the account associated with the user can offer merchant services to other user accounts while also sending customer requests to other merchants.

In an embodiment, an associated user, specifically, a customer can create an account in the software application. The customer account can contain identifying information associated with the customer including, but not limited to, user name, name, phone number, e-mail address, and/or a photo. The customer can also enter a password for use in subsequent access. Previously stored identifying information can also be modified by the customer.

In an alternative embodiment, the customer can access the software application using an existing account of an associated social media application permitted by the software application.

In an embodiment, the software application can store customer profile information associated with the customer account. The customer profile can include information stored in the customer account. The customer profile can further store information submitted by the customer. For example, the customer can enter the customer's city and/or gender. The customer can enter further information such as favorite requests. For example, the customer can enter favorite foods, condiments, and/or places to eat, which can be stored in the customer profile in the software application.

In a further embodiment, the software application can be configured such that the customer can designate opt-in/opt-out preference to receive notifications from the software application. The designated preference can be stored in the customer profile. The notifications can correspond to information general to all merchants. Alternatively, the notification can be a communication from an individual merchant.

In an embodiment, the software application can be configured to send a confirmation e-mail to the e-mail address entered by the customer in a newly created customer profile. The confirmation e-mail contains instructions on the process to verify the customer's e-mail address. The confirmation e-mail can also contain a link to a confirmation page.

The software application can be configured so that the customer can enter their username and password at the confirmation page to complete the confirmation process, if the customer is not currently logged into the software application.

The software application can be configured such that the customer can select a tutorial from the confirmation page.

In an embodiment, a new request can be created by the customer, for example, on the mobile customer device. The request can be assigned a type, for example, breakfast, brunch, lunch, dinner, or happy hour. The new request can use information stored in the customer profile. The new request can further include information entered by the customer. For example, the customer can select a location, choose an activity, and pick a date and time. The customer can enter further information such as party size, specific gender make-up of the party, anticipated spending per person, and further details including free text notes to be included in the request to the merchant. Customer requests can be linked to the customer profile and stored.

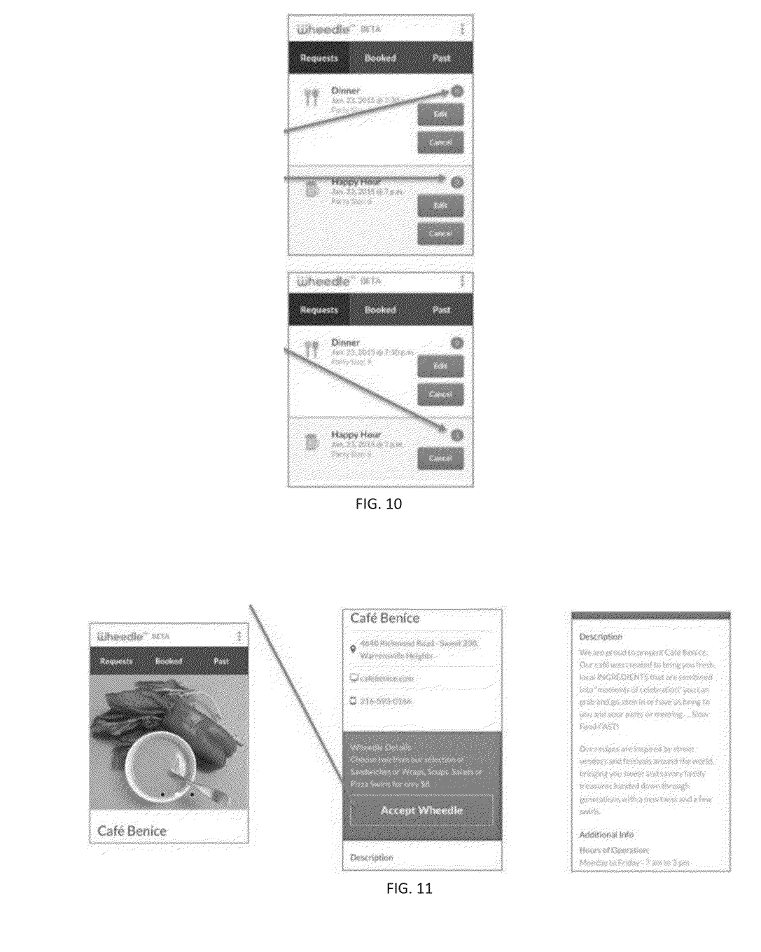

In an embodiment, pending customer requests can be accessed by the customer, for example, on the customer mobile device. Pending customer requests are customer requests that have been submitted and are awaiting further action by the customer based on received merchant responses. FIG. 10 shows an example of a user interface display of two different pending customer requests. Also displayed, in conjunction with each pending customer request, are the number of merchant responses received from merchants. The display of the number of merchant responses can be updated in real-time upon receipt. Requests that have received no merchant responses can be edited or canceled by the customer. Further, requests that have received at least one merchant response can be canceled by the customer.

The software application can be configured to expire any pending requests if no merchant responses have been received by a predetermined time period. The predetermined time period can be configurable by the customer.

The software application can further be configured to send a notification to a designated contact in the customer's profile in the event a pending request expires. For example, an e-mail can be sent to the customer's designated e-mail account or a text can be sent to a customer's designated phone.

Details of the pending request and summaries of any received responses can be accessed by selection of the pending request by the customer.

Details of a particular merchant response can be accessed by selection of the particular merchant response by the customer. The details of a merchant response can include, for example, photos, a description of the merchant, location information, cost information, private and/or special offers, contact information (for example, electronic mail and/or phone), detailed description of the merchant, hours of operation, and the like. FIG. 11 demonstrates an example user interface displaying a detailed view of a merchant response. The customer can accept the merchant response directly from the detailed view of the merchant response.

In a further embodiment, the software application can be configured to present a confirmation when the customer accepts a merchant response. The confirmation can include detailed information of the accepted merchant response (also referred to as a booked request or booking). The confirmation can further include information on how to claim the booking.

In a further embodiment, the software application is configured to allow the customer to edit contact information in the customer's profile for potential contact from the merchant by selecting an edit option directly on the confirmation. The updated contact information can then be stored in the customer profile. The updated customer profile can be used by the software application in the current booking.

In a further embodiment, the software application can be configured such that the confirmation includes the ability to share the booked request on social media selected by the customer.

In an embodiment, the customer can access booked requests. As presented above, booked requests (bookings) are pending requests wherein the customer accepted a particular merchant response. Bookings can display information from the merchant accepted by the customer.

In a further embodiment, the booking information can be shared with an external electronic calendar associated with the customer.

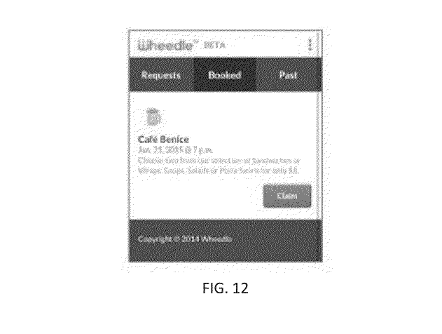

In an embodiment, at the time/date and location of a particular booking, the customer can access the particular booking in the software application, for example, on the customer mobile device. The request to claim the booking can be selected directly from the displayed booking. FIG. 12 demonstrates an example of a selected booking. The software application can then offer an input option for the merchant to enter a verification code to accept the claimed booking on the customer mobile device. The merchant can then enter a verification code to complete the claimed booking.

In an alternative embodiment, the software application can send the request for claiming the booking to the merchant, for example, to the merchant mobile device. At the merchant mobile device, the merchant can select the claim request and enter a verification code to confirm the claim.

In an embodiment, the claimed booking can be stored and accessed as a past booked request.

In a further embodiment, the software application can update customer profile information as a result of the claimed booking, including, but not limited to updates to integrity scores and badges.

The software application can be configured to assign score increases (or decreases) and/or badge assignments based on booking information. The booking information is compared by the software application to predetermined threshold values. The predetermined values are configurable in the software application.

For example, the integrity score of the customer is increased by a particular value when a particular number of bookings have been claimed. In another example, a badge is added to the customer profile. A badge can be given, for example, for “frequent user,” “big spender,” “high integrity score.” and the like, when a particular number of bookings or value of bookings have been claimed. Multiple badges can be awarded for multiple criteria.

In an embodiment, an associated user, specifically a merchant can access the software application using a merchant account created by an administrator of the software application. The merchant can access the software application with, for example, the merchant mobile device.

The software application can store a merchant profile associated with the merchant account. The merchant can update the merchant profile with information associated with the merchant's business. Merchant profile information can contain photos, name and description of the business, contact information including phone number, web site, physical address, and other additional information. The additional information can include, for example, hours of operation, price range, cuisine, parking, and payment options.

In an embodiment, the software application is configured to store and retrieve staff information entered by the merchant. Staff information can include, for example, name, e-mail, and password. Staff can use the given password to send premade merchant responses created by the merchant or to enter as the verification code to confirm claim requests from a customer, for example.

The merchant can also configure permissions for each staff member. The software application can be configured to allow the merchant to grant/deny permissions to staff for any functionality available to the merchant, including but not limited to sending premade merchant requests, sending custom merchant requests, creating and/or editing premade merchant requests, confirm claimed bookings, and/or managing accounts. For example, a first staff member can only send premade responses or confirm claim requests, while a second staff member can have exactly the same permissions as the merchant.

In general, a “merchant” user can also mean a “staff” user granted requisite permissions.

In an embodiment, the merchant can create and maintain premade merchant responses. The premade response can contain any information available to be sent in a merchant response. The premade response can contain, for example, an offer name, offer details, and photos.

In an embodiment, the merchant can view incoming customer requests, for example, using the mobile merchant device. Incoming customer requests are customer requests awaiting a merchant response.

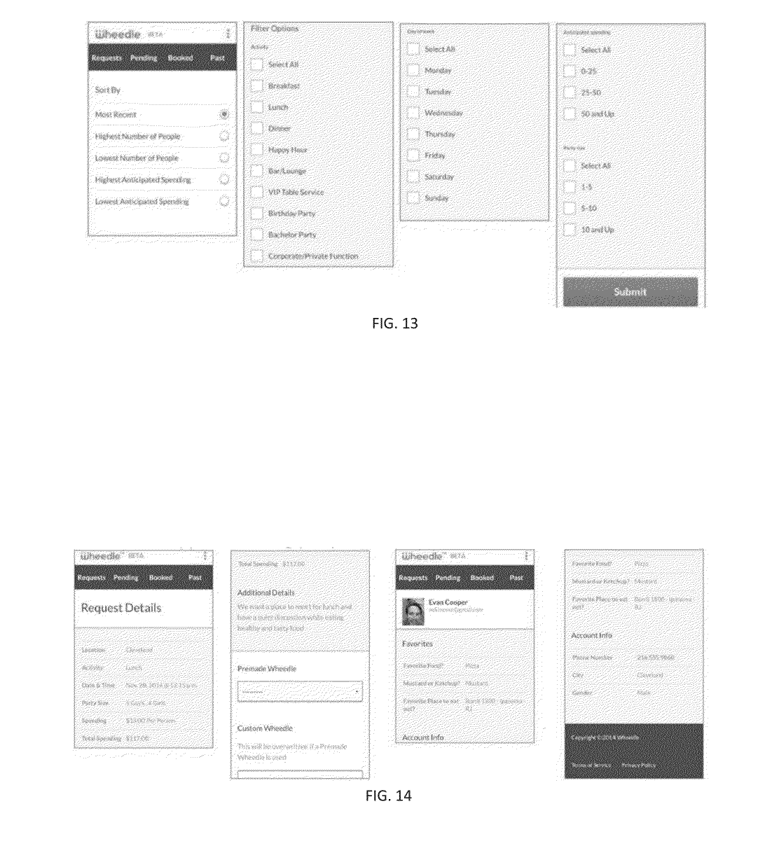

In a further embodiment, the merchant can sort and/or filter incoming customer requests. FIG. 13 illustrates an example user interface of merchant sorting and filtering options. The merchant can sort and/or filter based on any information contained within the customer requests. The software application can be configured to filter and/or sort by any information associated with customer requests, including but not limited to, customer profile information, customer request information and/or status, merchant response information and/or status, booking information and/or status, and the like.

For example, customer requests can be sorted by most recent, highest number of people, lowest number of people, highest anticipated spending, lowest anticipated spending, integrity score, party composition, and the like.

In another example, customer requests can be filtered by activity, for example, breakfast, lunch, dinner, happy hour, bar/lounge, VIP table service, birthday party, bachelor party, corporate/private functions, and the like. Customer requests can also be filtered by day of the week, time, anticipated spending, party size, and the like. In a further example, filtering can also be done by badge status and/or integrity score.

In an embodiment, the software application can display a list of incoming customer requests including a subset of information available in each customer request. The list of customer requests can be sorted and/or filtered as discussed above. The merchant can hide individual customer requests to remove that customer request from the displayed list.

In an embodiment, the merchant can send a merchant response directly from a particular customer request displayed in the list of incoming customer requests. The merchant response can be a premade merchant response or custom merchant response. The premade merchant response can be selected from a list of available premade merchant responses. The custom merchant response is created by manually entering all information to be included in the response.

In an alternative embodiment, the merchant can select a particular customer request from the list of incoming customer requests to display all information contained in the particular customer request. The merchant can then send a merchant response from the detailed display. The merchant response can be a premade merchant response or custom merchant response. The premade merchant response can be selected from a list of available premade merchant responses. The custom merchant response is created by manually entering all information to be included in the response.

FIG. 14 illustrates an example user interface display of a detailed customer request available to the merchant.

In an embodiment, the merchant can view pending customer requests. Pending customer requests are incoming customer requests wherein the merchant sent a merchant response that has not been accepted by the customer.

The software application can display a list of pending customer requests including a subset of information available in each pending customer request. The list of pending customer requests can be sorted and/or filtered as discussed above.

The software application is configured to allow the merchant to revoke a merchant request sent to any pending customer request.

In an embodiment, the merchant can revoke a sent merchant response directly from a particular customer request displayed in the list of pending customer requests.

In an alternative embodiment, the merchant can select a particular pending customer request from the list of pending customer requests to display all information contained in the particular customer request. The merchant can then revoke the particular sent merchant response.

In an embodiment, customer requests with revoked merchant responses are removed from the merchant's list of pending customer requests and are added back to the merchant's list of incoming customer requests. Similarly, the customer request with the revoked merchant response is updated accordingly in the consumer user's list of pending customer requests.

In an embodiment, the software application can be configured to automatically remove pending customer requests from the list of pending customer requests after a particular amount of time has passed. The software application can be configured such that the merchant can designate a value for the particular amount of time.

In an embodiment, the software application can be configured such that the merchant can define rules to automatically send predefined merchant responses based on parameters associated with incoming customer requests. For example, rules can be established based on time/date, amount, party size, party composition, event type, anticipated spending, integrity scores, badges, and the like.

The rules can be defined with multiple required criteria. For example, a merchant can define a rule such that if the event is X, and the party size is greater than N, and the anticipated spending is greater than or equal to $$$, then send premade merchant response AAA.

The merchant can further define the rules such that automatic predefined merchant responses are sent based on elapsed event time. For example, a customer request sent on Monday for event on Friday would receive an automatic predefined merchant request on Tuesday. In another example, a customer request for an event at 2 pm for a 7 pm event would receive an automatic predefined merchant response at 3 pm.

In a further embodiment, the merchant can configure the software application with information related to the merchant's capacity and reservation calendar.

The merchant can configure rules including conditional statements related to the entered capacity and reservation calendar information. For example, the merchant can construct a rule such that if the event type is X, and the party size is greater than N, and the anticipated spending is greater than or equal to $$$, and available capacity is greater than C at the requested date/time, then send premade merchant response AAA.

In an embodiment, the software application can be configured to restrict the number of automatic predefined merchant responses sent to a particular number per time period. The particular number and time periods can be configurable in the software application, for example, by a software application administrator.

In an embodiment, the software application can be configured such that the merchant can select multiple customer requests from a list of customer requests. The merchant can then send a common (or bulk) merchant response to each of the selected customer requests. The bulk merchant response can be predefined merchant response or custom merchant response.

In an embodiment, the merchant can define expiration criteria in merchant responses. For example, the merchant can define that the merchant response will expire based on a particular time value or multiple time values. The time value can be configurable in the software application by the merchant. For example, the merchant response can be defined to expire after 24 hours from when it is sent, or the offer will expire 24 hours from the event/time.

In a further embodiment, the merchant can define default values for expiration criteria. For example, the merchant can define that if an event in the customer request is greater than 24 hours from the send time of the merchant response, the default expiration is 24 hours from the event, or, if the event is less than 24 hours from the send time of the merchant response, then the default expiration is 2 hours before the event.

The default values can also be configurable by the merchant to be active or inactive for individual or bulk merchant responses.

In an embodiment, the software application can be configured to include the display of the expiration date/time on the customer request.

In an embodiment, the software application can be configured to remove a customer request with an expired merchant response from the pending customer requests list.

In a further embodiment, the software application can be configured to add the removed customer response associated with the expired merchant response back on the incoming customer requests list.

In a further embodiment, the software application can be configured to display information on the expired merchant response on the customer response associated with the expired merchant response when added back on the incoming customer requests list.

In an embodiment, the merchant can view booked customer requests (bookings). Bookings are pending customer requests that have subsequently been accepted by the customer. The list of bookings can be sorted and/or filtered as discussed above.

In an embodiment, the merchant can confirm a booking. A booking can be confirmed when the merchant enters the booking information into an associated reservation system. The booking information can be entered manually by the merchant or staff. The merchant or staff can then designate the booking as confirmed in the software application by a user interface, for example, a user interface associated with the merchant mobile device.

In an alternative embodiment, the software application can be configured to output the information directly to the associated reservation system and update the booking as confirmed.

As presented in more detail above, upon arrival of the customer, the merchant or staff can claim a booking, for example, using the customer mobile device or by using the merchant mobile device. The software application can be configured to update customer profile information as a result of the claimed booking, including, but not limited to updates to integrity scores and badges.

In an embodiment, the merchant or staff can designate a booking as a “No Show” if a customer fails to appear for an agreed upon booking. The merchant or staff can manually select a “No Show” from the user interface of the software application. Alternatively, the software application can automatically update a booking as “No Show” if a particular amount of time past the scheduled date and time of the booking has passed. The software application can be configured such that the merchant can designate a value for the particular amount of time.

In a further embodiment, The software application can be configured to update customer profile information as a result of the “No Show”, including, but not limited to updates to integrity scores and badges.

In an embodiment, the software application can be configured such that the merchant can view past bookings. Past bookings can include claimed bookings and “No Shows.” The list of past bookings can be sorted and/or filtered as discussed above.

In an embodiment, the software application can be configured such that the software application can generate push communications to customers who opt-in to receive these communications. The push communications can be sent from a specific merchant or from the software application in relation to merchants in general.

In an embodiment, the software application can generate a survey to customers that is configured such that results can be stored in the software application associated with the customer profile. The survey can be in the nature of games, applications, or specific code requests.

The survey can be customized to reflect customer preferences, for example, likes, dislikes, allergies, cravings, preferences, items to avoid, new interests (e.g., popular media), new experiences sought by the customer, and the like.

The survey can be customized to: rate items on sample menus, for example, a menu of a merchant the customer has visited, a merchant the customer would like to visit, or a hypothetical menu; or to rate food types, music types, and/or establishment atmospheres. It is to be appreciated that the list of items to rate can be of configurable depth from general to highly specific examples.

In an embodiment, the software application can be configured to generate suggested merchants to the customer based on comparison of preferences stored in the customer profile to information stored in merchant profiles. For example, the software application can suggest merchants that match the customer's preferences of culinary experiences, special deals, beverage tastings based on specific beverage preferences (e.g., beer, scotch, wine, bourbon, etc.), music offerings, and the like.

In an embodiment, the software application can be configured such that a user can generate reports based on data aggregated from stored customer profiles. For example, a merchant can request the software application to generate a report outlining the most common customer request combinations.

The software application can be configured such that the requested report will only aggregate data matching profile parameters designated by the user. It is to be appreciated that the designated parameters can be any set of parameters stored in the customer and/or merchant profiles.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of“may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system, comprising:
a processor in communication with a memory storing computer-executable instructions that, when executed by the processor, configure the processor to:
receive an event request for proposal from a customer computing device associated with a customer, the event request for proposal indicating a solicitation for services from a plurality of merchants for an event;
communicate the event request for proposal to a plurality of merchant computing devices respectively associated with the plurality of merchants;
receive a merchant proposal, responsive to the event request for proposal, from a merchant computing device of the plurality of merchant computing devices;
communicate the merchant proposal to the customer computing device;
receive an acceptance of the merchant proposal from the customer computing device; and
communicate the acceptance to the merchant computing device.

2. The system of claim 1, wherein the event request for proposal indicates at least one of a type of activity, a time and date, a location, a party size, or an anticipated spending amount.

3. The system of claim 1, wherein the merchant proposal includes a special offer specific to the customer.

4. The system of claim 1, wherein the processor is further configured to maintain a status of the merchant proposal, wherein the status indicates at least one of a pending state, a confirmed state, or a redeemed state of the merchant proposal.

5. The system of claim 1, wherein the processor is further configured to:
communicate redemption information to at least one of the customer computing device or the merchant computing device; and
receive at least a portion of the redemption information from at least one of the customer computing device or the merchant computing device to confirm redemption of the merchant proposal by the customer.

6. The system of claim 1, wherein the event request for proposal is public and the processor is further configured to:
communicate the event request for proposal to a plurality of customer computing devices associated with a plurality of customers;
receive requests from one or more of the plurality of customer computing devices to join the event; and
update the event request for proposal based on the requests to join the event received.

7. The system of claim 1, wherein the processor is further configured to communicate a template to at least one of the customer computing device or the merchant computing device, and at least one of the event request for proposal or the merchant proposal is based on the template.

8. The system of claim 1, further comprising a data store that includes profile information associated with at least one of the merchant or the customer.

9. The system of claim 8, wherein the processor is further configured to filter merchant proposals communicated to the customer computing device based at least in part on the profile information associated with the customer.

10. The system of claim 8, wherein the profile information can include an integrity score indicative of at least one of merchant performance or customer performance.

11. The system of claim 10, wherein the processor is further configured to:
receive review information from at least one of the merchant computing device or the customer computing device related to the merchant proposal; and
generate the integrity score for at least one the merchant or the customer based in part on the review information.

12. The system of claim 1, wherein the processor is further configured to:
receive a parameter from the merchant computing device;
identify event requests for proposal received from a plurality of customer computing devices based on the parameter; and
communicate the event requests for proposal identified to the merchant computing device.

13. The system of claim 1, wherein the processor is further configured to:
receive a parameter from the customer computing device;
identify merchant proposals from a plurality of merchants based on the parameter; and
communicate the merchant proposals identified to the customer computing device.

14. The system of claim 1, wherein the processor is further configured to utilize a plurality of rules to automate generation of the merchant proposal, wherein rules of the plurality of rules activate based on parameters of the event request for proposal.

15. The system of claim 1, wherein the processor is further configured to:
receive a counter proposal from the customer computing device; and
communicate the counter proposal to the merchant computing device.

16. A non-transitory computer-readable storage medium having stored thereon computer-executable instructions that, when executed, configure a processor to:
receive a plurality of event requests from a plurality of customers, the event requests indicate information associated with a plurality of events;
communicate respective portions of the plurality of event requests to a plurality of merchants based on respective criteria associated with the plurality of merchants;
receive a plurality of merchant proposals from the plurality of merchants, wherein respective merchant proposals of the plurality of merchant proposals are respectively associated with respective event requests of the plurality of event requests;
communicate respective portions of the plurality of merchant proposals to the plurality of customers; and
maintain respective statuses for the plurality of merchant proposals with respect to the plurality of event requests.

17. The non-transitory computer-readable storage medium of claim 16, further storing computer-executable instructions that configure the processor to:
receive review information related to the plurality of merchants or the plurality of customers with respect to the plurality of event requests or the plurality of merchant proposals;
track performance of at least one of the plurality of customers or the plurality of merchants with respect to the plurality of event requests or the plurality of merchant proposals; and
generate integrity scores associated with the plurality of customers or the plurality of merchants based on at least one of the review information or performance.

18. The non-transitory computer-readable storage medium of claim 16, further storing computer-executable instructions that configure the processor to:
match an event request to a merchant proposal based on an acceptance of the merchant proposal by a customer; and
generate a verification code to confirm redemption of the merchant proposal by the customer.

19. A system, comprising:
a computing device that includes a memory and a processor, wherein the computing device is in electronic communication with at least one of a customer mobile device via a first electronic communication or a merchant mobile device via a second electronic communication;
a software application stored on the memory of the computing device and executed by the processor of the computing device to perform the following:
receive data representative of an event request for proposal via the first electronic communication in which the event request for proposal includes a geographic location, a venue, a number of attendees, an occasion, and a price range;
create a new customer account or identify an existing customer account for the event request for proposal; and
store data representative of the new account or the existing account and data representative of the event proposal request;
receive data representative of a merchant identification via the second electronic communication in which the merchant identification includes a merchant location and a merchant name;
create a new merchant account or identify an existing merchant account for the merchant identification;
receive data representative of a query via the second electronic communication in which the query includes a parameter from the merchant mobile device;
communicate data representative of the event request for proposal to the merchant mobile device in which data representative of the event request proposal is communicated based on a query match of the query between the parameter and at least one of the geographic location, the venue, the number of attendees, the occasion, or the price range;
receive data representative of a merchant proposal from the merchant mobile device via the second electronic communication, wherein the merchant proposal is customized for and sent in response to the event request for proposal;
communicate data representative of the merchant proposal to the customer mobile device that is the query match;
receive data representative of an acceptance from the customer mobile device in response to the merchant proposal from the customer mobile device; and
communicate data to the computing device or the merchant mobile device indicative of the merchant proposal have been redeemed by a customer at the merchant location.

20. The system of claim 19, the software application further comprising an integrity score module that is configured to perform the following:
receive data representative of one or more reviews of the customer from one or more merchant mobile devices;
generate a performance rating for the customer based on the one or more reviews; and
store the performance rating with the existing customer account for the customer or the new customer account for the customer; and
communicate the performance rating and the event request for proposal to the merchant mobile device, wherein the performance rating is for the customer and the event request for proposal is communicated from the customer.
